(19) United States
(12) Patent Application Publication
(10) Pub. No.: US 2003/0179230 A1
(43) Pub. Date: Sep. 25, 2003

(54) Method and apparatus for providing remote peer-to-peer collaborative user interfaces

(76) Inventor: Gerry Seidman, New York, NY (US)

Correspondence Address: WILLIAM J. SAPONE, COLEMAN SUDOL SAPONE P.C., 714 COLORADO AVENUE, BRIDGE PORT, CT, 06605, US

(21) Appl. No.: 10/396,157

(22) Filed: Mar. 25, 2003

Related U.S. Application Data
(60) Provisional application No. 60/367,741, filed on Mar. 25, 2002.

(51) Int. Cl. G09G 5/00

(52) U.S. Cl. 345/750

(57) ABSTRACT

A method and apparatus for producing computer programs with real-time synchronized data models across multiple computers/devices and a mechanism for producing deeply collaborative user interfaces enabling multiple users to concurrently work together interactively and in real time. This mechanism enables users to concurrently have synchronized views of the same underlying data model or have desynchronized views of the underlying model enabling them to view different portions or rendering of the underlying model. Additionally this mechanism enables the creation of software applications where multiple users can concurrently modify different portions of the same underlying data models. Also included is a feedback mechanism using colors/patterns that indicates remote user focus, views, selections and sub-model data locks. To address unexpected or catastrophic propagation-web segmentation or participating peer termination in a synchronized model or collaboration, a method and apparatus for lock and data resolution is also described.

### TECHNICAL FIELD

This invention relates to a method of collaboration between users, customers, consumers or other participants with computer user interfaces. These systems may be presented on desktop/portable computers or PDA's (i.e. personal data assistants), or any other network capable devices with a Graphical User Interface (GUI).

### BACKGROUND

The increased utilization of computers and other electronic communication devices at home, in businesses and between businesses has expanded dramatically, as a result of the similar expansion in the amount of software and information available. Examples of the types of software include Word Processors, Spreadsheets, business applications for the collection, tracking, manipulation or dissemination of information, computer games as well as scientific research and applications.

Point of Presence Technologies, such as Instant Messaging, are becoming more common. Point of Presence enables users to automatically ascertain whether other users are online and working in an application via buddy lists and other types of feedback

It is typical for multiple users to remotely collaborate on documents generated from programs such as Word Processors, Text Editors and Spreadsheets as well as any number of document based applications that have a concept of “saving to a file”. A common method for collaboration is for users to transfer copies of the document back and forth via email, shared network drives, floppy disks or any other file transfer method. After the transfer of the document, typically one or more people involved will discuss the document over telephone, internet-Phone or Instant Messenger. Typically one of the participants will integrate any changes resulting from the conversation into the document and then send a copy of the new version to each of the participants. Common applications of this include Legal Contracts, Proposals, Manuscripts, computer source code, computer software configuration files.

### SUMMARY OF THE INVENTION

It is an object of the present invention to provide a technique for enabling two or more users/participants to simultaneously and remotely collaborate on software applications with Graphical User Interfaces (GUI) that utilize the Model-View-Controller or similar paradigms.

It is a further object of the present invention to provide techniques for creating remote viewers that concurrently render synchronized views/portions of a document/model over the internet enabling remote users/participants to collaborate on a document/model.

It is a further object of the present invention to provide techniques for creating viewers that can enable or disable remote view synchronization, allowing either the concurrently synchronized rendering of views/portions of the model/document or the rendering of different views/portions of the model/document.

It is a further object of the present invention to provide techniques for multiple synchronized remote views on the same model/document that is commonly accessible to all participants

It is a further object of the present invention to provide techniques for multiple synchronized remote views on a model/document that are replicated and synchronized on multiple remote machines/devices

It is a further object to provide a means providing meaningful feedback to the remote users/participants including, in applications such as Text Editors or Word Processors, feedback on which portion of the document the other users are viewing and feedback on which portion (if any) other users have selected.

It is a further object to provide techniques for providing meaning feedback to remote collaborating users/participants in applications such business or scientific graphical modelers and/or monitors. This feedback could include from selection or pointing gestures within the application.

It is a further object to provide a means providing meaning feedback for collaboration on any application utilizing the Model-View-Controller paradigm commonly utilized in Java, Windows and Motif based applications.

It is a further object to provide a means for collaboration on any application utilizing the Model-View-Controller paradigm utilizing the technique of synchronizing the viewport and gesture states of multiple remote viewers.

It is a further object to provide a means providing a mechanism for participants in remote interactive collaboration in applications including Word Processors or Text Editor Documents to express on-the-fly assignment and exchange of write locks of portions of the document indicating which participant can change that portion of the document, thus enabling multiple concurrent editing of the document.

It is a further object to provide a means providing a mechanism for participants in remote interactive collaboration any applications utilizing the Model-View-Control or similar paradigm to express on-the-fly assignment and exchange of write locks of portions of the model indicating which participant can change that model, thus enabling multiple concurrent modification of the model.

It is a further object to provide a means providing methods of graphical feedback that incorporate information about what the other users/participants are viewing.

It is a further object to provide a means providing methods of graphical feedback utilizing a variation of the common scrollbar in that incorporate feedback about what the other users/participants are viewing and which (if any) portions of the document are locked by the other users/participants.

It is a further object to provide a means for and a method of replicating and synchronizing data models in a Peer-To-Peer manner over a propagation-web.

It is a further object to provide a means for and a method of resolving locks and other orphaned data items in the event of unexpected or improper departure of participants in a synchronized model.

The above objects are achieved herein through the establishment of the invention which included the description and mechanisms for implementation of Distributed Model-View-Control, the mechanisms for producing synchronized data models across multiple computers/devices with distributed locking mechanisms, the mechanisms for establishing and utilizing propagation-webs to maintain synchronized data-models and views, mechanisms for producing synchronized views on synchronized or shared data models across multiple computers/devices, and a feedback mechanism using colors/patterns that indicates remote user focus, views, selections and sub-model data locks. Optionally, mechanisms for data/view and lock resolution are included in the event of propagation-web segmentation and/or unexpected/catastrophic demise of a peer from a synchronized model and/or collaborative viewing of a synchronized model.

### BRIEF DESCRIPTION OF THE DRAWINGS

FIG. 1: Multiple controllers providing input to a viewer

FIG. 2a: Multiple viewers rendering the state of a model

FIG. 2b: Multiple remote viewers rendering the state of a remote model

FIG. 3: Models Maintaining Synchronized State

FIG. 4: View Adjustors and Input Devices

FIG. 5: View Adjustors and Input Devices for a Text Area

FIG. 6: Model-View-ControlParadigm

FIG. 7: Model-View-ControlParadigm applied to a WordProdcessor or Text Editor

FIG. 8: Decoupled Distributed Model-View-Control with Synchronized Models

FIG. 9: Distributed Model-View-Control With shared Model

FIG. 10: Scrollbar Rendering Viewport

FIG. 11: Rendering View port with Remote Viewer

FIG. 12: Rendering Multiple Participant Model/Document Locks

FIG. 13: Feedback on how a Remote Peers is viewing the currently active local Viewer in a Multi-Document/Viewer application

FIG. 14a: Selection-State: Textual Document

FIG. 14b: Selection-State: Graphical Model-Element

FIG. 15: Distribute Model [symbol] View-Controller and Propagation-web

FIG. 16: Simple implementation of a Propagation-Web as O(n²) connections

FIG. 17: Complex Propagation-Web

FIG. 18a: Failure of a propagation-point in the web

FIG. 18b: Fragmentation into distinct models

FIG. 18c: Self-Healing propagation-web without message loss

FIG. 19a, b, c: Adding a participant to a Data Synchronization propagation-web

FIG. 20a: Initialization to a new participant in the model propagation-web

FIG. 20b: Model is now established in the propagation-web on new peer

FIG. 20c: Initialization to a new participant in the view-Controller propagation-web

FIG. 20d: View-Controller is now established in the propagation-web on new peer, View-Controller is associated with the appropriate Model

FIG. SS-1: Sample Application with GUI Sharing

FIG. SS-2: Feedback on remote Selection by User 1

FIG. SS-3: Feedback on remote Selection by User 2

FIG. SS-4: Remote Synchronized Scrolling

FIG. SS-5: Remote Typing by User 1

FIG. SS-6: Exchange of Lock on Document and Typing by User 2

FIG. SS-7: Independent viewing of shared document

FIG. SS-8: Feedback on multiple locks by different users

FIG. SS-9: Collaborative Design showing Synchronized Views with Model Lock Feedback integrated into the Controller

FIG. SS-10: Collaborative Design showing Desynchronized Views

FIG. SS-11: Collaborative Project Manager showing Synchronized Views with Locks on Project Entries and Feedback as Border Color

FIG. SS-12: Collaborative Project Manager showing Desynchronized Views

Table 1: Mirror-State Relationships between the local Peer's state and remote Peer's State

### DETAILED DESCRIPTION OF THE INVENTION

The present invention includes an extension of the Model-View-Control paradigm used in most Graphical User Interfaces. This extension enables various forms of deep feedback and interactivity for multiple remote users by a synchronization of the views independent from either a shared or synchronized Model using a Distributed Model-View-Controller.

This extension enables the creation of software applications where multiple users can concurrently modify different portions of the same underlying data models, and additionally, mechanisms for producing synchronized distributed data models with locking mechanisms and failure/segmentation resolution mechanisms. A feedback mechanism is included which uses preferably colors/patterns that indicate remote user focus, views, selections and sub-model data locks. While having color as the only possible feedback would not be appropriate for some users, particularly those that are color-blind, for illustrative purposes herein, all examples are shown using color as feedback.

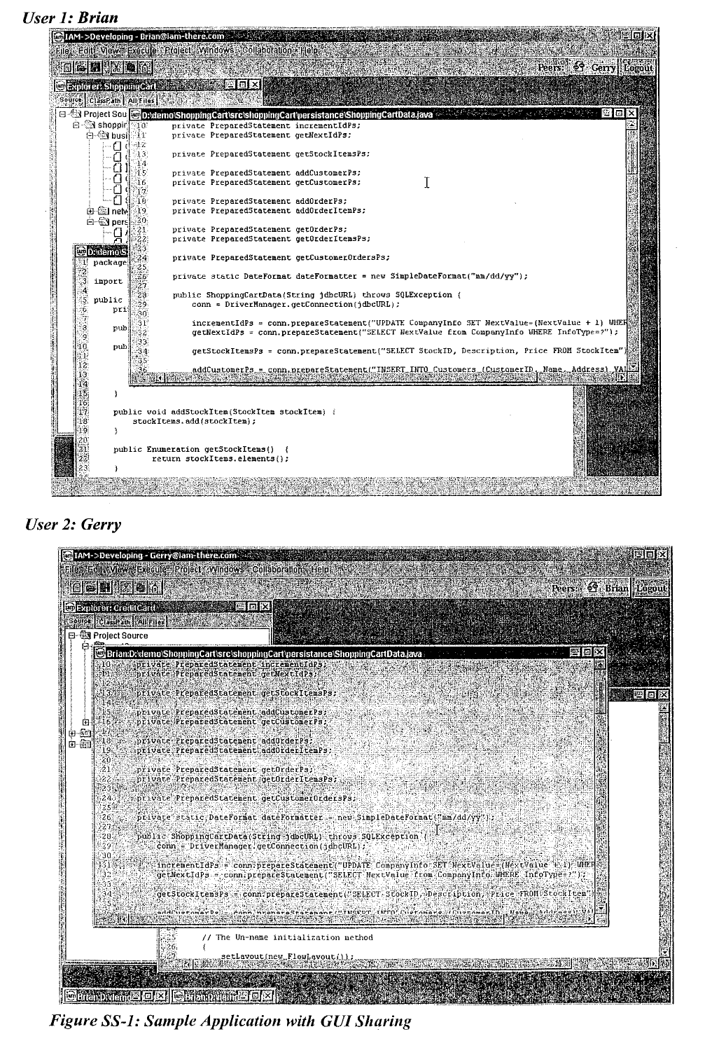

The typical Model-View-Controller approach to User interface architecture is presented in FIGS. 1-7 and described herein. As in FIG. 1, a Model (1) is any data object that may be modified by programmatic or external events by one or more Controllers (2). A Controller (2) is the source of that change. Controllers (2) can be programmatic based upon timers or network signals. In GUI Applications, the mouse and keyboard may also server as sources of input for a Model (1).

A viewer renders or displays the state of a Model to the User either in a Graphical or Textual manner on a computer monitor, PDA screen, etc or in the case of customized hardware using other mechanisms such as lights, meters, sounds, etc., possibly in combination with a graphical display.

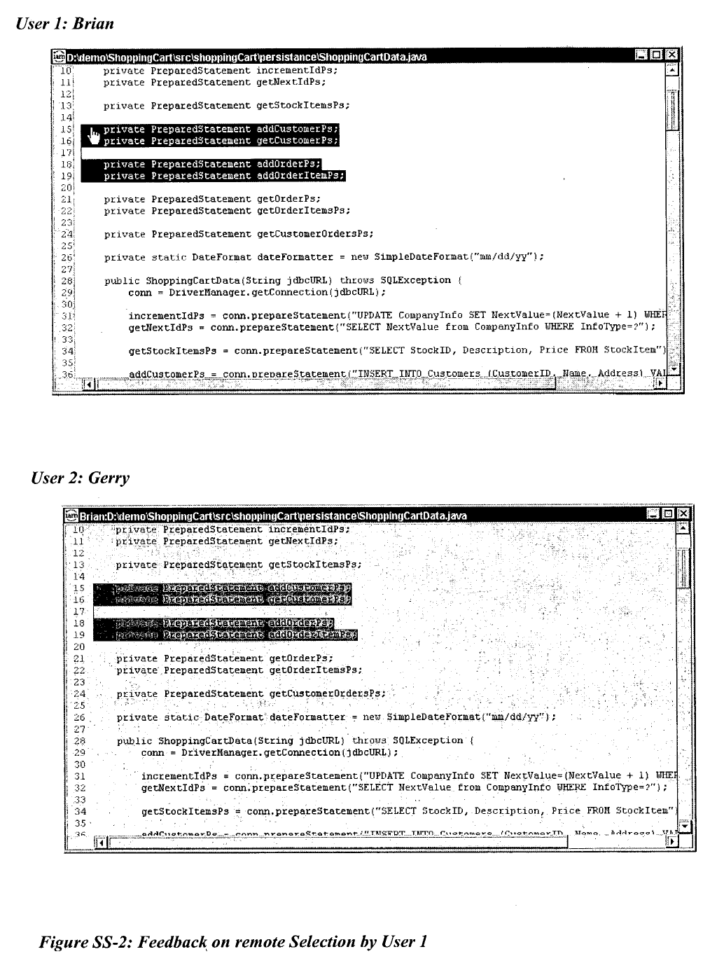

As in FIG. 2a, when the Model (1) is changed by a Control (2), it notifies one or more registered Viewers (2) of the change so they may render/re-render the model onto a graphical user display. In the case of a word processor, the model may be the internal representation of the document and the Viewer is what the user sees on the display.

If the View and the Model are on different machines, the View may be notified directly from the model via network messages (FIG. 2b). Alternatively, one of several techniques for maintaining replicated and/or synchronized models may be employed (FIG. 3). In this manner the respective models act like mutual controls, such that if either user modifies the other, any registered viewers would be notified of the event.

Data Models replicated and synchronized across two or more devices/computers employ mechanisms such that a change in the model by one of the participants will be propagated out to all participants possessing replicated versions of the model so that the state of the model remains consistent across all participants. These remote change events may be considered as Controls to the local model that is, they are then sent as control events to the locally registered viewers as with traditional Model-View-Control. One mechanism for Data/Model Synchronization is described later in this application.

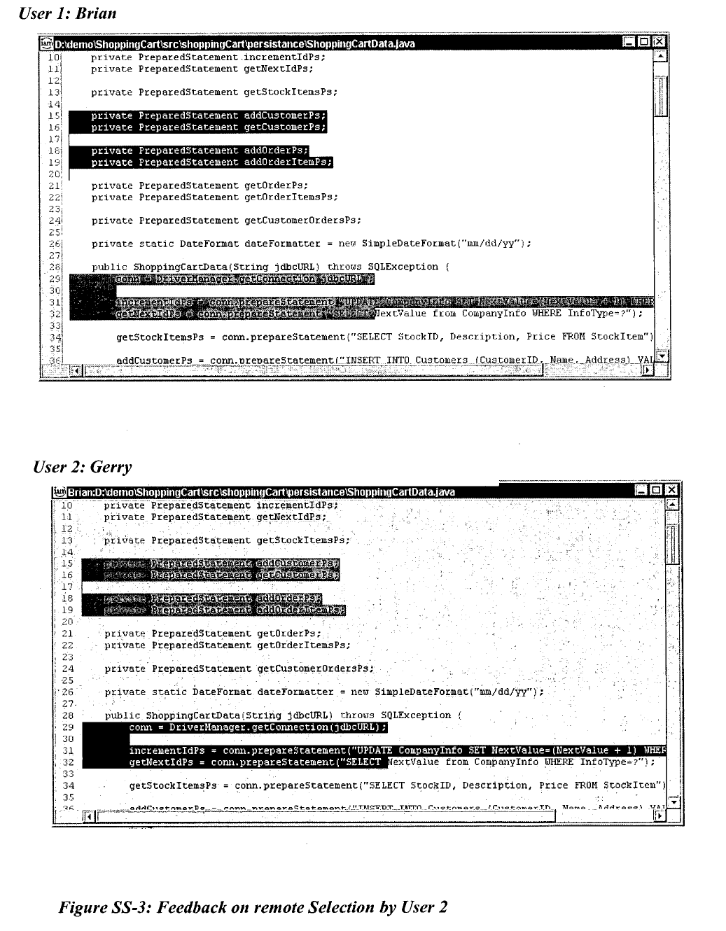

As in FIG. 4, most GUI Widgets and complex GUI Components are designed as View-Controllers. Typical Input Devices (5a) such as, but not limited to, keyboard or mouse can be used to adjust the View (3) via View-Adjusters(4). As in FIG. (5), View Adjusters may be things like Scrollbars on the Text Area of a Word Processor or Text Editor. The Input Devices (5a), may also be used to do other non-model modifying functions such as selecting an area of a document or designating a part in a CAD drawing. Alternately, based upon the design of the GUI devices, the same Input Device (5b) can act as a Controller (2) to the Model. For example a common keyboard mapping command found in a word processor, such as Control-A, may perform the non-modifying action of selecting all the text in a document, while a similar keyboard mapping command such as Control-X will delete a selected region, thereby acting as a controller sending a modification event (“delete selected region”) to the model.

In FIG. 10, we can see that View Adjustors such as a Scrollbar can be used to provide feedback to the user as to which view port into the underlying model is currently being rendered by the Viewer. In the case of the Scrollbar, the size of the bar relative to the entire scrollbar is proportional to the size of the view port relative to the document while the position of the bar indicates the position of the view port into the document.

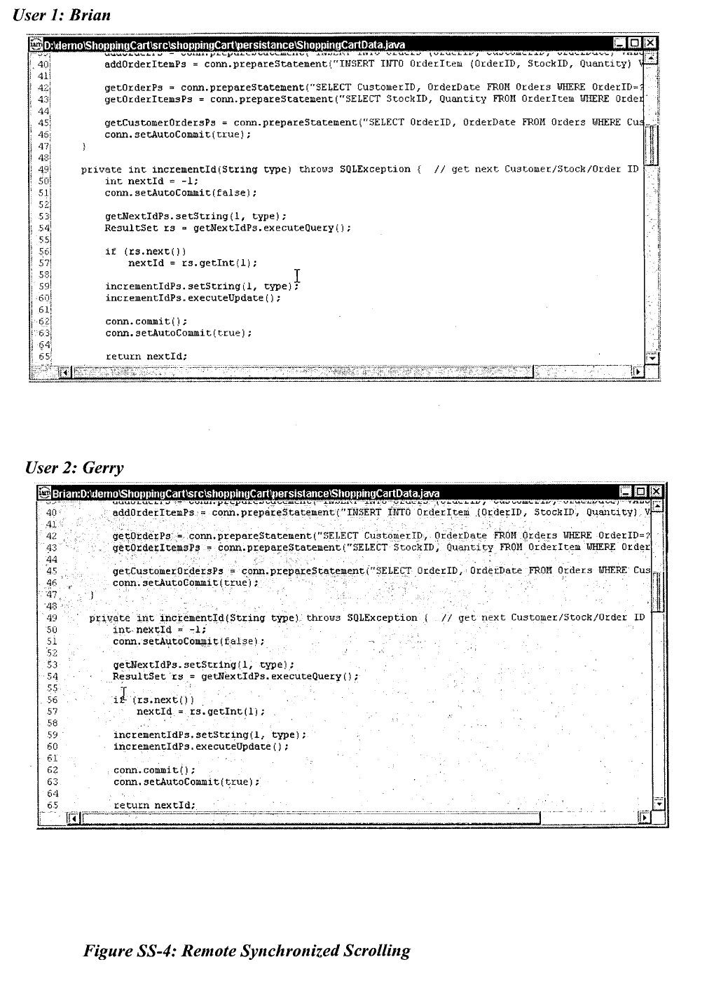

In this regard, often the aggregate of (3), (4), (5a) and (5b) are sometime referred to as View-Controllers, as in FIG. 6 and act like any other controller on the Model (1). FIG. 7 shows this for a typical text area in a Word Processor.

The View-Controllers maintain a state independent from the state of the model. For example, a text area associated with a particular model maintains which portion of the model is currently being displayed, what (if anything) is currently selected, etc. This state, along with the state of the model, affects how and/or what the viewer renders as well as how Input Device events get transformed into Control Events. Each participating peer maintains its own View-Controller State, though this state is propagated and replicated on every collaborating peer.

The View-Controllers State for each peer typically includes:

View port State: This affects what portion of the model is rendered in the viewer. Depending on the type of model and viewer the complexity of this state varies. For example in the viewing of a text document, the View port State is simply which lines/columns of the underlying document are currently visible in the text area. It could also specify whether the document is displayed in Normal, Outline, or Page-Layout Mode as well as the document Zoom-scale. For 2D/3D graphical modeling such as CAD or Scientific/Financial Modeling or Page Layout applications, it may include position, scale and rotation of the Model to be displayed. For Time-Based models such as animation, weather patterns, etc it will include the time and/or frame rate.

View Rendering State: This affects how the model is rendered in the viewer. For example in a Text Document viewer, it could indicate whether Images are rendered. For 2D/3D graphical modeling applications, it may include complexity of mesh rendering and texture mapping, presence of wire-frames, anti-aliasing, etc.

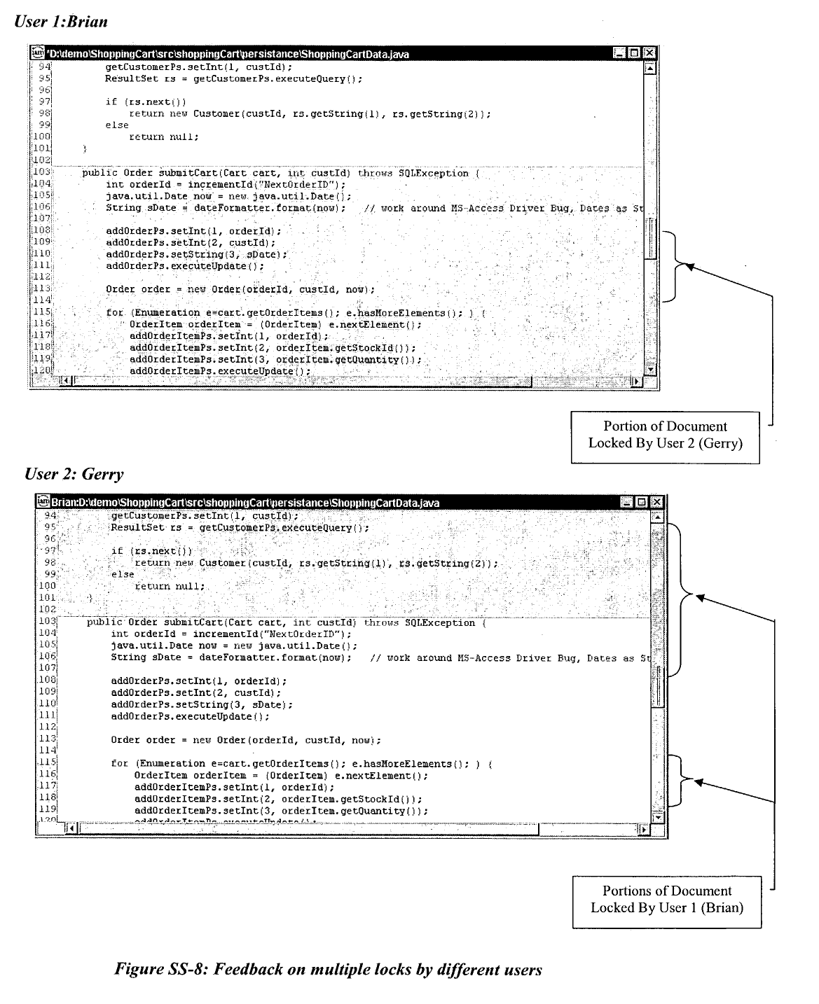

Selection State: This indicates what the current user has selected. In a text Document, this is what the user has selected using standard mouse and/or keyboard actions. For 2D/3D graphical modeling applications it corresponds to which model-elements the user wishes to act on. In either case, there is an application/viewer specific feedback to the user to confirm/indicate what has been selected such as text being highlighted in reverse color or an outline around the model-elements selected, as in FIGS. 14a and 14b. In the non-collaborative scenario, Selection State indication is input for a subsequent application level command, such as copy, paste, rotate, change font/color, etc. In the collaborative scenario it has the additional benefit of specifying what remote users are referring to, even if there is no follow up command by any user acting on the selected items.

Mirroring-State: This indicates how changes in the state of other peer's View-Controller will affect this peer. It also indicates how this peer would like other peers to be affected by Viewer-Controller state changes by this peer. This aspect of the state determines whether a local viewer has synchronized or desynchronized viewing relative to another peer/participant. Alternatively the relationship may be one of leading the view of another peer (but not following), or following the view of another peer (but not leading them). The Mirroring-State may be multifaceted allowing different aspects of the viewer to be synchronized or not (i.e. Viewport State, but not every aspect of the View-Rendering State).

In this invention, the state of the View-Controllers state for each participating peer is propagated across all participating computers/devices using mechanisms similar to model/data synchronization. But unlike the state of the model, which should be maintained as a single consistent state across all participants, the View-Controller State of each participant may be different. As such, the state of every participant is determined only by the local user/peer, but its state is replicated and synchronized across all participating peers, FIG. 15. In this manner, utilizing the Mirroring aspect of the View-Controller State, applications may choose locally to synchronize all or part of the View-Controller's state with another peer/participants View-Controller State. If the View-Controllers on two peers are mirroring each other's internal state, then the Users will see similar/identical views, i.e. their views are synchronized. According to the invention, view-controller state items, such as selection state, may be rendered locally in a per user/peer manner providing feedback on remote gesturing of remote users.

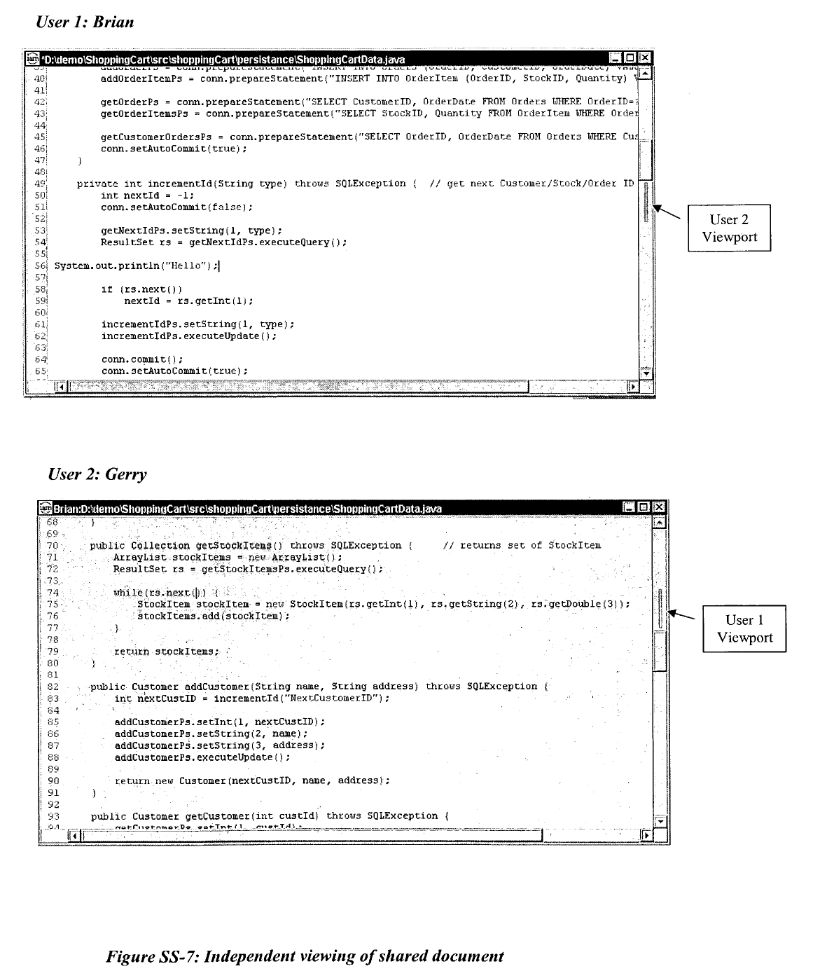

In this invention, the Model-View-Control paradigm is extended in the Distributed/Collaborative environment by maintaining View-Controller State replication of each peer/user across all peers/users. Then, based on local application-level settings, the View-In Controller may optionally modify all or part of its own state to match one or more remote users/peer's state resulting in synchronized views. Note that the level of view synchronization or Mirror-State of a particular peer should also be propagated out to all participants allowing feedback as to whether remote users are viewing similar or different views as the local user, FIG. 13.

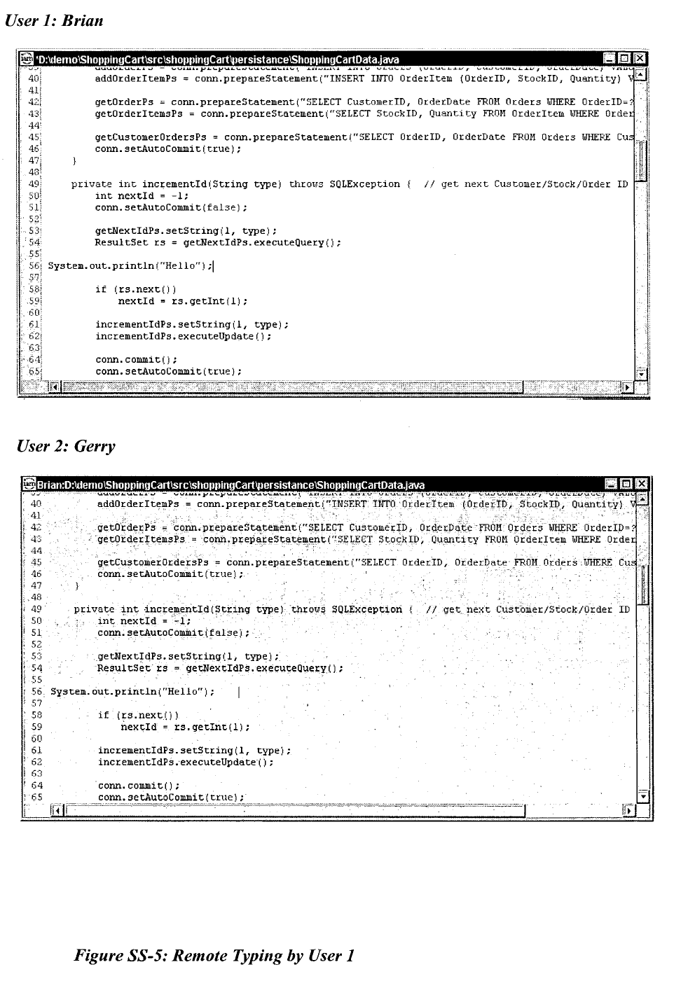

This technique for synchronizing Viewer-Controllers may be used with either a synchronized local copy of a replicated Model as in FIG. 8 or with a single/shared central model as in FIG. 9.

Each Participating Peer would have a View Controller as in FIGS. 8 or 9. As the user locally modifies the view it would broadcast this Viewer state change to each participating viewer. This can be done via standard or proprietary network messaging or remote procedure techniques. In this manner, each Viewer would know both its own state as well as all of the participating Viewers state. For example with a Text Area, this Viewer state would include the current visible View port. The Visible View port includes the first and last visible line/column on the display as well as the total size of the document. It would also include the cursor position and start/end selection region if there is any.

Using a multitude of techniques for synchronizing models as in FIG. 3, either a single Peer can have change/write privileges for the model at a given time or using distributed locking techniques various peers may have write control over different parts of the model. One such technique is described later herein. User feedback mechanisms must be employed to indicate which user has the lock on which parts of the model.

In this invention, an integral part of the success of the remote user interaction includes the depth of feedback that can be augmented upon common feedback devices/widgets, particularly using colors or patterns associated with each user/peer that is involved in the collaboration. A modified version of the standard scrollbar is one way to feedback significant information about what remote users are doing by integrating remote peer feedback into the scrollbar display. In addition, document background color may be used to indicate which user has the lock on all or part of the underlying model/document. This may also include the state of the remote peer/user's View port State (i.e. what are they looking at), which elements/portion of the model have been selected by the remote user/peer (i.e. their Selection State), which elements/portions of the underlying model are locked by yourself and which remote user/peer have other elements locked. Custom or specialty devices may also be implemented using color/patterns to provide similar feedback. For example, with the text area, the background color can be used to indicate which user has the lock all or part of the document and/or by highlighting in a different shade of the color the remote user/peer's Selection state could be rendered.

While the presentation of this technique utilizes a syntax-colorized Text Document as seen in the progression of Screen Shots, the same approach may be used for Formatted Text or non-text Models or Views. This technique may be applied to any GUI that utilizes the Model-View-Control Paradigm or any similar paradigm. Also, in the presentation of this technique, only two users/peers are interacting. The same technique works for an arbitrary number of users/peers with each user/peer having a color/pattern associated with them, as in FIG. 15 with three participants.

In FIG. SS-1 we see a sample application utilizing this technique of Remote Collaboration. In this figure, the two users, Brian (User 1) and Gerry (User 2) have already connected with each other. On the title bar, you can see the name of the logged in user. On the toolbar, they can see each of the remote users/participants they are collaborating with via their name in a box with a unique color. In this case, green has been assigned to the respective remote (Brian on Gerry=s machine and Gerry on Brian's machine). For each additional participant that would be involved in the collaboration a different color would be assigned. In this manner, there is a strong feedback relating color to a particular remote user. In this application the color white represents the local user. Please note that in each of the figures the top screenshot represents User 1 (Brian) and the bottom Screen Shot represents User 2 (Gerry).

The Text Area background color feedback of white (local user) on User 1's display (top) indicates that User 1, Brian, has the ability to change the document/model, that is, Brian has the lock on the entire document/model. The background color feedback on User 2's display (bottom) is green which indicates that the green user (Brian) has the ability to change the document. Only one user/participant may have write/change privileges for a particular piece of the document/model at a given time. As described earlier, locks can be on the entire document or on portions thereof, and there can be multiple locks on the document.

In FIG. SS-2, User 1 (top) changes the state of his local Viewer by selecting a region of text, the local feedback on his machine is the normal feedback of a selected region. As described above this state change is broadcast to the remote Peer Viewer and is rendered locally on User 2's machine (bottom) utilizing the feedback color of User 1. In this example a darker shade of User 1=s color is used to indicate the remote Peer's selected area (dark green).

In FIG. SS-3 we see a similar interaction whereby User 2 selects a portion of text (bottom). The feedback to the local action for User 2 is the normal local feedback. This state change of User 2's view is broadcast to User 1's machine and it is rendered in User 2's color on User 1's machine as a remote Selection by User 1 (in this case also with a dark green color).

This rendering of the remote selection gesture would/could be used in conjunction with a telephone call or Instant Message session to augment the interaction.

In FIG. SS-4 we see the rendering of a Remote View port change. User 1 (top) changed the state of his local view by scrolling the display downward. In this example, User 2's machine (bottom) is configured to render (show) remote view port changes by User 1. As a result User 2's display automatically scrolls along with User 1.

The relative Mirror-State between User 1 and User 2 determines the type of Viewer Synchronization and is preferably presented to the user using icons on the toolbar, see FIG. 13 which shows a description of peer/Viewer/Controller-synchronization interaction icons. Table 1 shows additional possible relative Mirror-States between peers.

In this mode, utilizing synchronized scrolling along with remote selection, remote users can use gestures to express what they are both looking at while discussing it over the phone or IM.

As we will later see in FIG. SS-7, the Mirror-State settings can be such that independent View ports (onto different portions or angles of the Model) are maintained between participants enabling participants to see different parts of the model.

In this mode, along with remote selection, a remote user can express remotely what they are looking at while discussing it over the phone or IM.

In FIGS. SS-2 through SS-4 are shown remote feedback based View Adjuster Input Devices (5a).

FIG. SS-5 shows User 1 (top) typing into the text area (adding line 56 in the screen shot's text), provides type (5b) Input (as in FIG. 6), the kind that changes the Model. Whether we have views interacting with local synchronized models as in FIG. 8 or whether the participants are utilizing a common remote model as in FIG. 9, the results are the same. The change caused by User 1's signals to the model result in an event to User 2's Viewer (bottom). As a result, typing onto User 1's View is seen on User 2's View.

In FIG. SS-5, User 1 had the write/change lock for the model. An application level gesture or menu item by User 2 could request and then receive a change of the lock attributes on the model from User 1 (top) to User 2 (bottom). In particular the lock state of the entire model or model sub-elements is part of the model. As a result, transfer of lock ownership for a model or model-element is propagated in the same manner as with any model change to all participating peers. It is important to note that in the implementation of synchronized models described later in this invention, every element in a model must have a lock owner, though it may be transferred among participants. This is not the case with a central shared model since locks are centrally managed. As a result of the lock ownership model change, the local viewers on each participating peer will get a local event/signal about this change. In this example, the result is FIG. SS-6, a flipping of the background color (since the feedback in this collaborative text area utilizes the background color to indicate the lock owner for a fragment of the document). The background color feedback of white (local color) is now seen on User 2's View (bottom) indicating that User 2 now has write/change privileges for the document. Similarly the color feedback of green on User 1's display indicates that his green peer (User 2) has write/change privileges for this portion of the document.

Furthermore in FIG. SS-6, we see that now that User 2 has write/change privileges they may now provide Type (5b) input (i.e. model changing input). This can be seen by User 2's typing in of line 61 in the text area in the screen shot.

Note that while at most only one participant may have write/change privileges (a lock) for a portion of the model/document guaranteeing no conflicting concurrent modifications. As described later, there is a mechanism for transferring of lock ownership from one peer to the next (and recovery in the advent of catastrophic termination of a peer while it holds a lock). On the other hand, there are multiple View-Controller states for each View-Controller, one maintained by/for each peer/user, but these do require locks since each peer can only modifies its own state (with state changes propagated out to each peer upon modification). For example, in the text area example, either or both can simultaneously have the right and ability to scroll and make selections in the view. While attempting to synchronize views, concurrent user/peer scrolling can produce ambiguous results while attempting to match the view based on conflicting data change events, it is not destructive and easily resolved (by immediate discussion among the peers) since the collaboration is most likely done in conjunction with a telephone call or Instant Message session.

While one user is modifying one portion of the document, such as one paragraph, it is possible that the other participant may wish to look at another portion of the document. In the configuration seen in FIG. SS-4, scrolling on one View resulting in scrolling in the Peer's view, which while advantageous when discussing a common issue, is annoying if one is trying to type or read something. With this in mind, it is advantageous to have user controls to modify the local view controller's mirror state as well as feedback to the user for each participating peer regarding the way the local and remote view controllers are interacting (see FIG. 13 and Table 1). Each peer may have as part of its View-Controller the state FOLLOW (i.e. have the Viewer Rendering portion of its state mirror) the View-Controller state change events from a particular peer. Note that the Follow state can be implemented to maintain for each peer or may consist of a single value used for all peers. Additionally each peer may have as part of its View-Controller state the desire to have other another Peer be the LEAD, indicating that, if the local View-Controller state is “Following”, you wish that they mirror your state. In particular, if two peer's View Controllers both have Lead and Follow activated, their Viewers will remain synchronized, if they are both deactivated, they are desynchronized and users may concurrently view different parts of the same model as in FIG. SS-7.

In FIG. SS-7, User 1 (top) has write/change privileges on the document and is busy typing. While User 1 is typing, User 2 (bottom) wishes to desynchronize viewing. Via a local user interface such as a control key or menu item, he disables Following of User 1's View port State Changes as well as disabling leading on his own Mirror-State. At this point User 2 may scroll independently while User 1 continues working in his Viewport. Since the change User 2 made to his Mirror-State is propagated out to User-1, User-1 can have an iconic feedback indicating that User 2 no longer is following, see FIG. 13. Changes that User 1 makes to the model are propagated to User 2's Model and through the Model to his View. If User 2 scrolled over the same View region that User 1 was typing onto, he would see the changes as they are made.

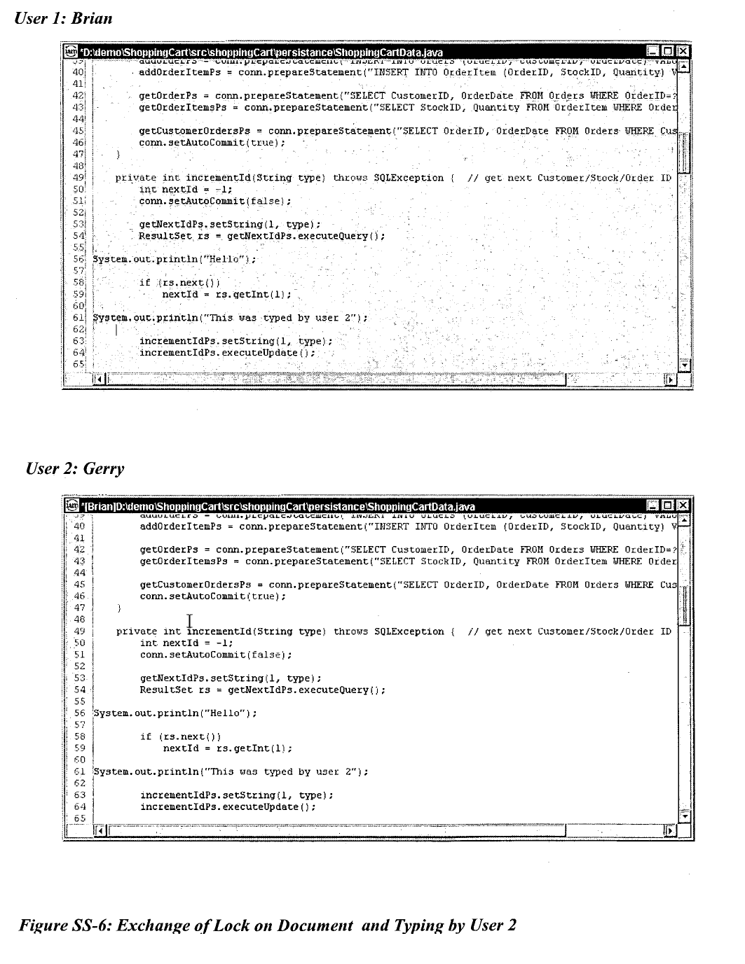

This invention includes the feedback mechanism for such decoupled viewing as seen in the modified scrollbar in FIG. SS-7 (both top and bottom). This remote feedback scrollbar utilizes the assigned remote user color to augment the feedback. A thin opaque line in the remote user's assigned color is superimposed upon the scrollbar in a position corresponding to the remote user's view port. In FIG. 11, we can see the relationship of the remote view port to the rendering on the local scrollbar. In this example, the thin green line seen in the scrollbar area of User 1 (top) display indicates the view port region that User 2 (User 1's green user) is currently viewing. In essence User 2's remote scrollbar is superimposed upon User 1's scrollbar (but as a thin opaque line in the users color). Similarly, User 2's scrollbar is superimposed as a thin opaque green line on top of User 2's scrollbar (bottom).

If there were more user/participant=s there would be additional thin scrollbars, one each in the assigned color for each remote user. This feedback remains practical up to four or five simultaneous participants, though most common interactions will involve two or occasionally three people.

In this manner of feedback users can remotely ascertain which portion of the document participants are currently viewing. This feedback was active in FIGS. SS-1 through SS-6 where the feedback indicated that the remote user was viewing exactly what the local user was viewing since their scrollbars coincided.

This invention includes additional feedback mechanisms for model/documents where multiple regions in the document can have write/change privileges assigned to various participants. Background color is used to indicate which user has the write/change privilege for a particular portion of the document. FIG. SS-8 shows a viewport straddling a region that is locked by different users.

On the top of FIG. SS-8, we see User 1's display the background color feedback of white (local color) indicate that User 1 has write/change privileges on lines 94-102 of the display. Lines 103-120 on the display have a background color of green indicate that User 2 (User 1's green Peer) has write/change privileges for those lines.

Symmetrically, you will see that the bottom of FIG. SS-8, the colors are reversed on the respective region indicating that User 2 has write/change privileges for lines 103-120 (in the local color, white) and that User 2=s green peer (User 1) has write/change privileges for lines 94-102.

This invention provides additional feedback about the state of the write/change privileges of the entire document/model superimposed upon the modified scrollbar. In FIG. 12, we see the relationship between the various locks held on the model and the bands of colors fed back onto the scrollbar. In our example, FIG. SS-8 (top) there is an opaque green region rendered on the scrollbar. This feedback indicates a Model attribute indicating that this region of the document/model is currently under write/change privileges by the green user (User 1). The regions in the default (local) scrollbar color (in this case gray) indicate the portions of the document where User 1 was write/change privileges.

On the bottom of FIG. SS-8 (User 2), there are two banded regions rendered in the green remote peer (User 1) color. There is a single grey band (towards the bottom), indicating the portion of the document/model that User 2 has write/change privileges.

In FIGS. SS-1 trough SS-7, the model was entirely locked by one or the other user. In these cases, the background color is sufficient feedback to indicate which participant has the write/change privilege. An equivalent decision to render the scrollbar as in SS-8 could have been made.

This type of feedback utilizing background color and the modified scrollbar exhibited in FIGS. SS-1 through SS-8 can be utilized in an identical or modified manner on Unformatted or Formatted Text Viewers, Tree Viewers such as XML or File Explorer Viewers as well as List Viewers.

The modified Scrollbar can be used in most feedback situations where regular scrollbars are rendering aspects of View state.

The general technique of decoupling Viewer rendering can be applied to any situation where the Model-View-Controller or similar Paradigm is used such as Word Processors, Spreadsheets, business applications for the collection, tracking, manipulation or dissemination of information, computer games as well as scientific research and applications.

As the number of users grows beyond four or five, the number of colors/patterns feedback may begin to be confusing. It is not necessary to have a color/pattern associated with all users/peers. For example in a presentation mode of working, at the application-level, some users may not have the ability to edit, select/annotate, or change views independently. In this case they would not require a color/pattern.

Examples of Feedback Mechanisms

Screen Shots SS-9 shows this technique applied to a 3D Graphical View of Model. In this case the entire model consists of the length, width, height and color of the car (represented as an RGB value or mapped to a Hue/Saturation/Value). The entire View port-State is represented by the two spherical rotation-angles around a central point (that are controlled by mouse drags on view area). The View-Rendering State consists of a single boolean value toggling line rendering on/off. In this example there is no selection state.

Here, each of the model values (width, height, length, color) can be independently locked. The values and control are represented in the Slider/ Value-Label widgets at the top of the viewer. The background color of the Slider/Value-Label is the Viewer Feedback for which user/peer has the change-lock for a particular aspect of the model (width, height, length, color), where white indicates the local user has the change lock.). Non-white colors in the Slider/Value-Label indicate which remote user/peer has the change lock for this aspect of the model. If you have the change-lock, dragging in the Slider/Value-Label changes the model (which is synchronized by model change propagation to other users. The user interface for requesting the change lock for an aspect of the model consists of a single click in the Slider/Value-Label of that model aspect. This causes the lock owner to relinquish the lock to you (which in turn is propagated as a Model Change to all participants and then to all viewers)

The button labeled “Lines On” enables the local user to change his View-Rendering State by toggling local rendering of mesh lines. The “Sync Views” button toggles the follow/lead values in the Mirror-State for the View-Controller.

In FIG. SS-9, User-1 can change the length/width while user 2 can change the height and color. The views are synchronized so if either rotates the car the other would mirror the rotation.

In FIG. SS-10, the views have been desynchronized enabling User 1 and User 2 to look at different angles of the Car/Model, but they are still able to independently and concurrently change the aspects of the model that they have change locks. Specifically, User-1 can change the length/width while user 2 can change the height and color.

In FIG. 11, there is another example with a collaborative Project Management application. In this example the Model consists of a collection of tasks. Each Task either has a reference to another task and a relative start date to that base task or it has an absolute start date (for root tasks). Each Task also consists of task duration and a descriptive label. In this example, each constituent Task in the model may be independently locked. The View-Controller shows each Task superimposed upon a time-line calendar. In this example, the border color of the task indicates who has the lock, where a black border indicates the local user. As with the previous example, the user interface for obtaining locks consists of single clicking the task. The controller aspect of the View Controller consists of dragging Tasks to change their start dates and to show the relationships to other tasks. Dragging their right edge changes the task duration. Besides requesting locks (if you don't already have it), single clicking on a Tasks corresponds to a selection (resulting in a Selection-State Change). This is fed back with corner squares. Selection-State is used locally to specify which Task gets keyboard input for changing the label. Remote Task Selections augments communications between remote talking via IM or telephone to indicate which Task is being referred to. View port synchronization is, as with the text area, restricted to the scrollbars indicating which part of the project plan is being viewed by the remote user.

FIG. 12 shows desynchronized viewing while one peer is changing the relative start date of a task.

Synchronizing Data Models Across Multiple Computers/Devices

The mechanism for Peer-to-Peer Replication and Synchronizing Data Models with Distributed Locking Mechanisms and Catastrophic Lock Resolution is described in three parts, mechanisms for providing a Complete Reliable message Propagation-web, mechanisms for replicating and synchronizing data on a reliable message propagation-web, and catastrophic Lock and Data Resolution mechanisms in the advent of a Peer Failure or segmentation of the propagation-web

A message Propagation-Web is a mechanism for getting messages across the network to all members of an established or ad-hoc group of peers. Joined Multicast Groups are an example of an implementation of a Propagation-Web, though it is unreliable.

The simplest implementation of a reliable Propagation-Web is one where every peer maintains a bidirectional connection (such as a socket) with every other peer with O(n²) connections. Message transmission is then simply iterating across all connections to the complete web as in FIG. 16. A variation of this simple implementation could employ HTTP Tunneling, which would enable creation of a propagation-web that traverses firewalls.

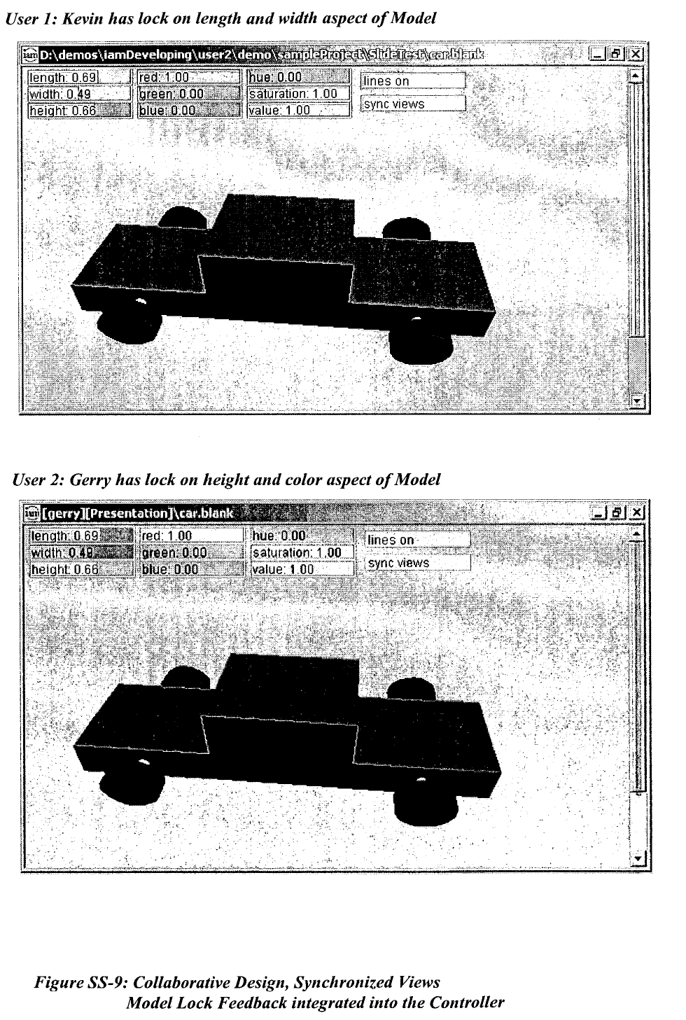

Other Propagation-Web implementations could more optimally propagate out messages to all participants, such as in FIG. 17. Project JXTA (http://www.jxta.org) implements propagation webs of this type as Propagation Pipes. Though the current public implementation is not considered reliable, a frame-buffer and/or ack-protocol can be layered on top of it to provide reliability.

Multiple propagation webs may be interleaved over shared transports between multiple Computers/Devices as with JXTA, BEEP or other protocols supporting multi-channel communication.

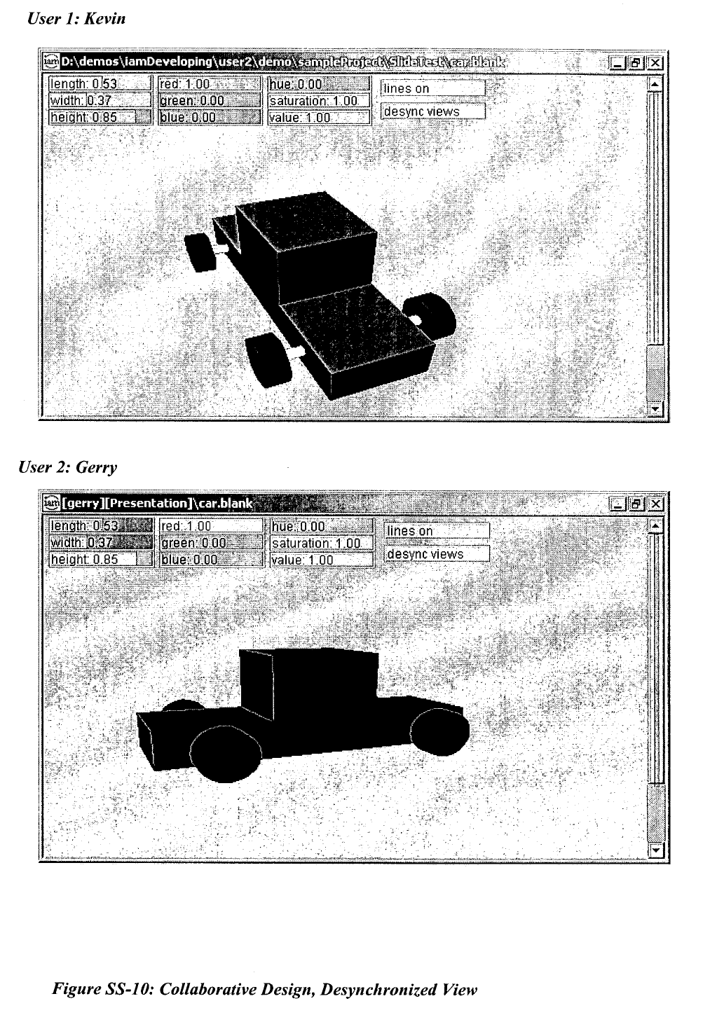

It is not the intention of this invention to define the sole implementation of a reliable propagation-web, but rather to define the aspects of this invention which may rely upon such a propagation web which should have the following attributes. The Propagation-Webs should be scoped to some identifiable context, a single entity can create a scoped Propagation-Web (with itself as the only/initial entry), there is a mechanism for joining the propagation-web through an existing member of the web, the propagation-web should survive the departure or failure of its creator, if a member is no longer able to receive messages, that participant should be removed from the web (though aggressive retry algorithms and message caching may be employed to avoid this failure condition). There should also be well defined notification of peers joining, leaving or failing in a propagtion-web, the group may fragment into separate survivable but distinct clouds (see FIG. 18a and 18b). The propagation-web may self-heal without message loss as members drop or become unavailable (see FIG. 18c). This does not require any notification to participating peers. During the process of new member joining, any messages received by the member introducing the new participant occurring from the beginning to the end of the join process may need to be redelivered to the new participant. In the advent of duplicate or already-processed messages to a participant, they are ignored.

The mechanism described here for data replication and synchronization has a reliable propagation-web. Each Data Model that is synchronized across multiple computers/peers will correspond to a distinct propagation-web. Data Models are replicable and their constituent elements must have a mechanism enabling the serialization/de-serialization into binary blocks (such as Java Object Serialization or XML) for transmission over the network.

The process of a peer joining a model synchronization propagation web begins with it receiving a complete copy of the model from the inviting peer:

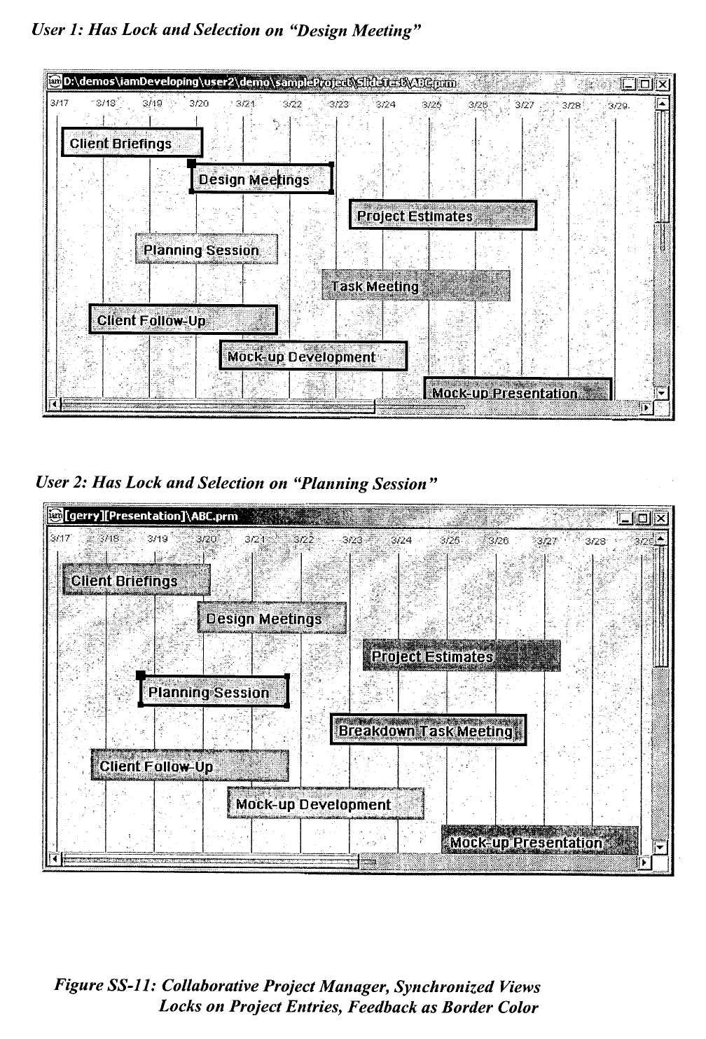

Peer-3 asks Peer-2 if it may join (FIG. 19a)

Peer-2 accepts and sends Peer-3 the type of model it required and a complete copy of the constituent data (FIG. 19b)

Peer-3 is now a member of the propagation-web and will receive all messages (FIG. 19c)

Note: Any Change Messages received by Peer-2 during its sending of the state of the model to Peer-3 will also be sent to Peer-3

Regardless of the underlying data structure, every model will contain constituent model-element that corresponds to the atomic units of change across to replication web. Each of these model-elements will have a single change-lock owner. Model change-messages are only meaningful if they come from the change-lock owner of that element of the model. When a model is first created (but not yet replicated) all elements are change-locked by the creator.

Once a member has joined the web and has its own complete copy of the replicated model. Since there is a complete and reliable propagation mechanism, all models will stay in sync since every model change message will be delivered to every participant that will be incorporated locally in the same manner on each participant.

Based upon how the propagation web is implemented, to assist in guaranteed message delivery and caching/resending of change-messages during the joining process, there may be benefits to having all model change messages to be uniquely marked. These messages could be transiently cached by the inviting peer and then resent to the new peer so that no change messages are lost during the initialization period. Change messages from each peer could contain a message number and as part of the model, each peer could keep tabs of the most recent message number integrated into their model from each participating peer. This would enable any peer to discard duplicate or already integrated change messages. This could also be used with framing and acknowledge-messaging in maintaining guaranteed message delivery.

The technique developed here can apply to any data structure (unordered or ordered), particularly standard data structures such as Singleton (the model with a single element, i.e. single lock), LinkedList, Hashtable/HashMap, and/or Trees.

For any Data Model implemented using this mechanism, each constituent Model Element that corresponds to an atom of locking and change has the following data associated with it:

Interface ModelElement {

Peer getCreator( );

Peer getLockOwner( );

void setLockOwner(Peer peer) throws NotOwnerException

Will getWill( );

void setWill(Will will) throws NotOwnerException

}

Model Element Data

Creator (Immutable), Change-Lock Owner (Mutable), Will (Mutable) [optional], Model Specific Element Data and other Structure Maintaining information.

The Creator and Change-Lock Owner are represented as unique Peer Identifiers corresponding to one of the current (or past) participants of the Propagation-Web. The Creator is the original peer who added the Model Element to the Model. The Change-Lock Owner corresponds to a current member of the propagation-Web that has the right to send change events or to relinquish lock ownership to another peer. The Will is described later, but corresponds to a set of rules for dealing with model elements if/when there is a natural or catastrophic departure of a member/members of the group, possibly while they still possess locks on that element.

Note that the Model Element interface above corresponds to the internal Model Elements of a particular Replicated/Synchronized Model. The Application Level API view of the Model need not expose its elements in this manner.

Change events that go over the propagation web for any model element will be one of the following type: Add/Change, Delete, or Change Lock-Owner. Add/Change messages must includes the new/replacement value for the Model Element and any other structural information to maintain the integrity of the data structure.

When applied to unordered data structures, this technique can be implemented in a manner such that concurrent adding of new element by any participant can be accomplished without any special lock management.

An example is applying this to a String-keyed Hash Table with Name/Value pairs. The values must be objects that have some mechanism for serialization/de-serialization as mentioned earlier.

Rather than keying on a simple string Key to enable any peer to add elements without requiring concurrent insertion communications with other peers, this implementation of the Hash Table will key on the Creator/Name pair rather than just the Name. Only the local peer can insert elements with its peer identifier as the value of Creator, guaranteeing no key conflicts between remote peers when adding new elements. When new elements are put into the Hash Table, the change-lock for that element set to the adding peer. Since the actual key used is Creator/Name pair and peer identifiers are unique, any peer can add an element hashed to any Name with itself as creator regardless of whether other peers utilize the same Name. Note that once created, the change lock for elements created on a Peer can be transferred to any other peer.

Note that there is a special value of Peer Identifier, SELF, that is always normalized to be the local peer and is meaningful even if the model is only resident on the local Computer/Device, i.e. not replicated.

Due to the asynchronous nature of distributed multi-locked models the following API would be appropriate for a distributed synchronized hashtable:

Class Distributed Synchronized Hashtable:

void put(Peer creator, String name, Object value) throws NotOwnerException;

void remove(Peer creator, String name, Object value) throws NotOwnerException;

Peer getLockOwner (Peer creator, String name);

void get(Peer creator, String name);

void setLockOwner (Peer creator, String name, Peer newChangeLockOwner) throws NotOwnerException

void addDistributedSynchronizedHashtableListener(String name, DistributedSynchronizedHashtableListener listener);

void addDistributedSynchronizedHashtableListener(Peer creator, String name, DistributedSynchronizedHashtableListener listener);

Iterator getPeersWithCreatedEntries( );

Iterator getPeersWithLockedEntries( );

Iterator getNames( );

Iterator getPeersUsingName(String name);

Iterator getNamesCreatedBy(Peer creator);

Iterator getNamesLockedBy(Peer lockOwner);

Interface DistributedSynchronizedHashtableListener:

void elementAdded(DistributedSynchronizedHashtableEvent evt);

void elementChanged(DistributedSynchronizedHashtableEvent evt);

void elementRemoved(DistributedSynchronizedHashtableEvent evt);

void elementChangedLockOwner(DistributedSynchronizedHashtableEvent evt);

Class DistributedSynchronizedHashtableEvent:

Peer getcreator( )

String getName( );

Object getvalue( )

Object getOldValue( )

Peer getLockOwner( )

Peer getOldLockOwner( )

Peer getChangedBy( )

Change messages that go over the propagation-Web with fields corresponding to the fields of the DistributedSynchronizedHashtableEvent that are not locally available to the model receiving the change message.

Type: Add, Change, Remove, Change-Lock Ownership

Creator: Peer Identifier:

Key Name: String

Value: Serializable Object

Lock-Owner: Peer Identifier

Changed-By: Peer Identifier

Propagation-web messages are received, they are applied to internally to local hash tables using Creator/Name keys. If there are corresponding listeners, local events are sent to the registered listeners.

Due to the asynchronous nature of distributed systems, many powerful application level uses can be made from the listeners (either creator/name listeners or just name listeners that will get events corresponding to that name from any peer), for example, the distributed Hashtable can be used as the basis for a lightweight Remote Procedure call mechanism where the name of the key corresponds to some method and the value corresponds to the parameter: table.put(SELF, “Foo”, val) corresponds to the (PeerID, “foo”) listener to be called on remote peers.

By only listening to your own PeerID, this provides a semantic mechanism to invoke the method “foo” on peer PeerID with the parameter val.

As we shall see later, the Mirror-State for Viewers are propagated utilizing a Distributed hash table associated with each viewer: viewerAttributes.put (SELF, “LEADING”, Boolean.true). Similarly by adding listeners to “LEADING”, the local viewer gets informed every time any remote peer changes its Mirror-State. This same technique can be employed to keep tabs on all of the View-State attributes.

This implementation of the DistributedSynchronizedHashtable is an example the most flexible type of model to use and implement since elements can completely manage their own locks without any structural interference with the underlying data structure maintained across the participants in the propagation webs.

Models where it is more rigorous structure may require a general lock for the model itself that must be used for specific model operations.

Interface Model {

Peer getcreator( )

Peer getLockOwner( )

void setLockOwner(Peer peer) throws NotOwnerException

Will getWill( )

void setWill(Will will) throws NotOwnerException

Peer[ ] getPeers( );

}

In particular, Models will fall into the following categories:

Atomic (only Model Lock owner can add/remove/change)

Cardinal (only Model Lock owner can add/remove)

Every Element has a Lock Owner

Only Model Owner can add/remove Elements

Element Change-Lock Owner can Remove Elements via a compound event

Relinquish Change-Lock ownership for the Element to the Model Lock Owner

Model-Lock owner removes Element

Non Model-Lock Owners can emulate additions via Compound events

Request the addition/insertion of an element to Model owner

Model-Lock owner adds/inserts the element

Model-Lock owner relinquishes Change-Lock ownership for the Element to the initial requesting peer

Non-Lock-Owners can emulate deletions via Compound events

Relinquish Change-Lock ownership to Model-Lock owner with delete request

Model-Lock owner removes element

Concurrent (anyone can add elements)

Every Element has a Lock Owner

Any Peer add/remove Elements

Element Lock owner can Remove any locked Element

Hashed Elements are keyed on Key/Creator pairs

Only Meaningful for unordered Collections

For models that require internal structure, such as Linked Lists and Trees, it may be advantageous for synchronized data models to assign unique internal identifiers, which can be accomplished either by allocation by the Model Lock owner or via local generation using the local peerId to guarantee uniqueness. This unique identifier is referred to as the handle for that element.

For example, in a typical LinkedList, the following is a sufficient API:

Class LinkedList {

Object getFirst( );

Object getLast( );

Object removeFirst( );

Object removeLast( );

void add(Object value);

void addFirst(Object value);

void addLast(Object value);

boolean contains(Object value);

boolean remove(Object value);

void clear( );

int size( );

}

When implementing replicated/synchronizable Models, it is the local Peer's responsibility to notify the model of local elemental updates, i.e. local changes to the content of a Model's element. An update will cause a change message to be sent across the propagation-web.

For the DistSynchLinkedList, the following is a sufficient API:

Class DistSynchLinkedList implements Model {void update(Handle handle, Object newValue) throws NotOwnerException;

Handle update (Object oldValue, Object newValue);

Handle getHandle(Object value);

Peer getLockOwner(Handle handle)

Peer getLockOwner(Object value);

void setLockOwner(Handle handle, Peer newChangeLockOwner) throws NotOwnerException

void setLockOwner(Object value, Peer newChangeLockOwner) throws NotOwnerException

Will getWill(Handle handle);

Will getWill(Object value);

void setWill(Handle handle, Will newWill) throws NotOwnerException;

void setWill(Object value, Will newWill) throws NotOwnerException;

void addDistSynchLinkedListListener(DistSynchLinkedListListener listener);

Object getFirst( );

Object getLast( );

Object removeFirst( );

Object removeLast( );

Handle add(Object val);

Handle addFirst(Object val);

Handle addLast(Object val);

boolean contains(Object val);

boolean remove(Object val);

boolean remove(Handle val);

void clear( );

int size( );

}

Where the handle is the unique internal identifier corresponding the model element, it is necessary to invoke the set methods so that the appropriate Change-Message can be propagated out to the other participants in the web for this synchronized model:

Interface DistSynchLinkedListListener {

void elementAdded(DistSynchLinkedListEvent evt);

void elementChanged(DistSynchLinkedListEvent evt);

void elementRemoved(DistSynchLinkedListEvent evt);

void elementChangedLockOwner(DistSynchLinkedListEvent evt);

}

Class DistSynchLinkedListEvent {

Peer getCreator( )

String getHandle( );

Object getvalue( )

Object getOldValue( )

Peer getLockOwner( )

Peer getOldLockOwner( )

Peer getChangedBy( )

Add }

The corresponding Change Messages that go over the propagation-Web contains fields corresponding to the fields of the DistSynchLinkedListEvent that are not locally available to the model receiving the change message.

Type: Insert, Change, Remove, Transfer Change-Lock Ownership

Creator: Peer Identifier:

Handle: Handle

InsertAfterHandle: Handle

Value: Serializable Object

Lock-Owner: Peer Identifier

Changed-By: Peer Identifier

Another example of replicated/synchronized Data Models would be an implementation of a Nested Data Model as a collection of logically separate named sub-models. This would require a slight augmentation to the Change Message format by the addition of a sub-Model identifier.

For example if a Nested Model had a Distributed Hash Table as a sub-model called “myAttributes”, a nested Change-Message could have a format as follows:

SubModelName: myAttributes

SubModelChangeMessage:

Type: Add, Change, Remove, Transfer Change-Lock Ownership

Creator: Peer Identifier:

Key Name: String

Value: Serializable Object

Lock-Owner: Peer Identifier

Changed-By: Peer Identifier

The Nested Model is particularly useful since it does not force a single Model structure on complex application-level domain/business object. As shown later in this application, View-Controllers can be implemented as Nested Models with the various aspects of the View-Controller states as sub-models.

Lock/Data Resolution for Normal or Catastrophic Propagation-Web Changes

Participants in a propagation-web may come and go either via normal notified departure or catastrophically via lost or non-responsive participants. Due to the Peer-To-Peer and self-maintaining nature of replicated/synchronized Models, it is possible that the model becomes unstable when a peer/peers depart. For example, a peer may have an active change-lock when it departs. Alternatively, it is possible to have a model that may semantically inconsistent if it contains elements created by peers no longer in the propagation-web.

To address this problem, there is introduced a concept of a Will that can be associated with every Element in the model. A Will is a strategy object that describes what actions must be taken on an element in the advent of changes to the membership in the propagation-web.

Interface Will {

Peer getLockOwner(ModelElement modelElement,

Model model,

Peer removedPeers[ ],

boolean abnormalDeparture);

}

This would return the (possible unchanged) lock owner after applying the Will or null if the Will ascertains that the element should be removed.

The following is a set of typical Wills:

ReassignLockOwnershipToSurvivorWill

An ordered list of participants is maintained with this type of will.

If, due to fragmentation of the propagation web, one or more peers are removed, lock ownership will be assigned to the first member on the provided list that still is a member of the propagation-web.

ReassignLockOwnershipToModelLockOwnerWill

Reassign Lock Ownership To Model-Lock Owner

This type of will only is appropriate for Models that maintain Model-Locks.

RemoveElementIfCreatorDepartsWill

Remove Element if the Element's creator has departed

RemoveElementIfLockOwnerDepartsWill

Remove Element if the current Change-Lock owner has departed

Other wills with alternate strategies can be created

Wills can be associated with any/all elements of a Model. A default Will should be associated with every model for elements that do not have Wills explicitly specified. Only the Change-Lock owner has the ability to change a Will for an Element. Only the Model-Lock owner can change the default Model-Element Will. A Will should also be specified for the Model itself, particularly for lockable models. Only the Model-Lock owner can change the Model's Will.

Wills must be serializable/de-serializable since they may be remotely set, i.e. there needs to be a mechanism to copy them over the network.

Whenever the membership of a Propagation-Web changes, every participant is notified. The Will provides a mechanism for applying appropriate strategies to normalize the model when participants leave the propagation-web so that:

There are no Changed Locked Elements by peers that are no longer participating

Semantically, elements may automatically be removed based upon strategies

The Will provides a mechanism to locally update a model when participants depart based solely on the membership change and yet guarantees that the models remain synchronized within a propagation-web

This technique works when propagation-webs are segmented. While the distinct fragmented clouds that form will no longer be able to maintain synchronized models between themselves, models within a particular cloud remain synchronized.

Every Model will handle Peer Departure in a model-specific manner:

for <all Elements in a Model>{

ModelElement modelElement=<next Data Element>

Peer oldLockOwner=dataElement.getLockOwner( );

Peer newLockOwner=will.getLockOwner(modelElement, model, removedPeers, abnormalDeparture);

if (newLockOwner==null)

<remove model Element from Model>

if (!newLockOwner.equals(oldLockOwner)) {

<Set modelElement's LockOwner to newLockOwner>

<Notify any registered Listeners of Lock Ownership Change>

}

}

It may be important that application-level listeners are able to distinquish between programmatic transfer of Change-Lock ownership and Will-Based Change-Lock ownership. The listener/event APIs need to reflect this. Below is an augmented API for the Distributed Synchronized Linked List with Will changed Lock ownership transfer notification capabilities added.

Interface DistSynchLinkedListListener {

void elementChangedLockOwnerByWill(DistSynchLinkedListEvent evt);

void elementAdded(DistSynchLinkedListEvent evt);

void elementChanged(DistSynchLinkedListEvent evt);

void elementRemoved(DistSynchLinkedListEvent evt);

void elementChangedLockOwner(DistSynchLinkedListEvent evt);

void elementChangedLockOwnerByWill(DistSynchLinkedListEvent evt);

}

Class DistSynchLinkedListEvent {

Peer[ ] getRemovedPeers( )

boolean isAbnormalDeparture( )

Peer getcreator( )

String gethandle( )

Object getValue( )

Object getOldValue( )

Peer getLockOwner( )

Peer getOldLockOwner( )

Peer getChangedBy( )

}

Mechanism for Implementing Distributed Model/View-Control

The following describes a mechanism for producing synchronized views on synchronized or shared data models across multiple computers/devices. This technique utilizes the techniques for establishing and maintaining replicated/synchronized Data Models described above.

In this method of implementation, Synchronized Models exist in the manner described above as participants of a propagation-web for that Model. Synchronized Models maintain a single consistent state across all participants.

Synchronized Viewer-Controllers maintain their own state for each of the following:

View port State

View Rendering State

Selection State

Mirroring-State

As described earlier, to feedback remote user's state, actions and intent (both visually and by gestures), in addition to maintaining their own states, View-Controllers must have a copy of these states from of all participating peers.

This can be achieved by having the state of the View-Controllers implemented as a distributed hash table where each participant maintains creator/name elements for each aspect of its own state which will then be automatically replicated on all participating View-Controllers in the web. Correspondingly, the values from all other participants in the View-Controller propagation-web are automatically updated as they change via the data synchronization mechanisms described in this invention.

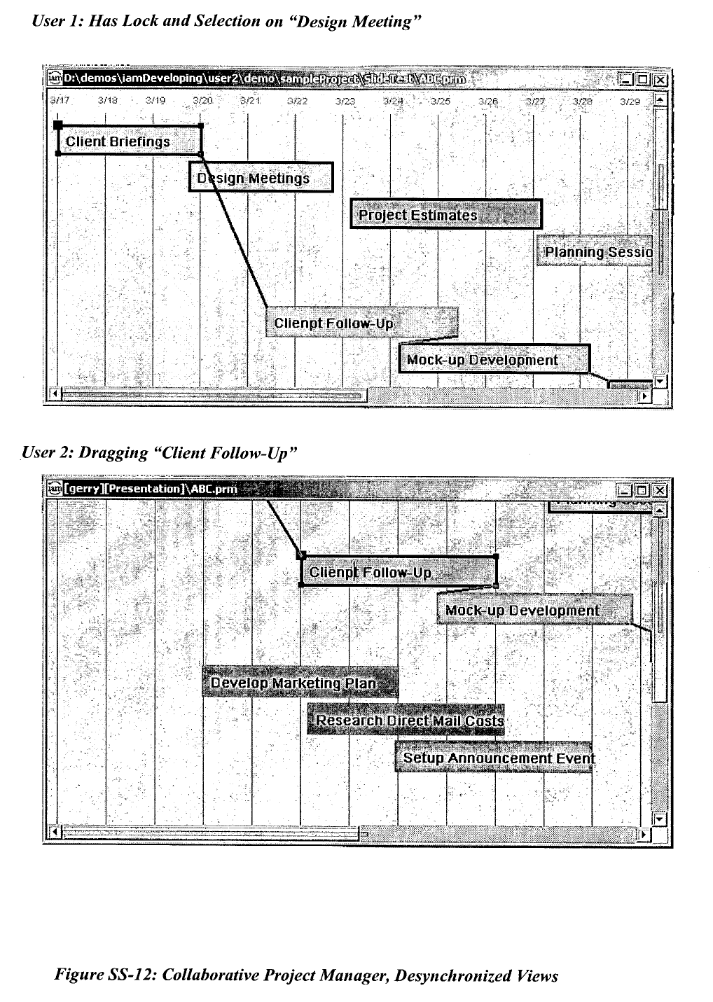

Based upon an application-level trigger or user action, the process of replicating a model and then the corresponding view-controller from Peer B to Peer D may be initiated, FIG. 20a. The Model is a participant in the model's propagation-web (which may contain one or more peers, in this example it is seen as the red web of Peer-A, Peer-B and Peer-C) in FIG. 20a. The View-Controller is a participant in the view-controller's propagation web (which may contain one or more peers, but can not include any peers not in the model's propagation-web, in this example it is seen as the green web of Peer-A, Peer-B and Peer-C) in FIG. 20a.

FIG. 20a shows Peer-B initiating the transmission of the copy of the model to Peer-D. In order for Peer-D to be able to create a local copy of the model of the appropriate (object) type, the initiating message must include model-type information to help Peer-D instantiate a local object of the correct (model) type. This local object can then be initialized with the model state data sent by Peer-B. It is not necessary that the implementations of the model be written in the same programming language or even be exact in their implementation. It is only necessary that the messaging protocols are compatible

FIG. 20b shows that the Model has been initialized and appropriately integrated into the model's propagation web (red). This is similar to the process described earlier.

FIG. 20c shows Peer-B initiating the transmission of the copy of its View-Controller to Peer-D. For Peer-D to be able to create a local copy of the View-Controller of the appropriate (object) type, the initiating message must include view-controller type information to help Peer-D instantiate a local copy of the correct (viewer) type. This local object can then be initialized with the view-controller state data sent by Peer-B. It is not necessary that the implementations of the View-Controller be written in the same programming language on Peer-D as Peer-B, or even be exact in their implementation. For example if Peer-B is a High-Resolution desktop computer and Peer-D is a PDA, the respective implementations of the View-Controller would probably be different. It is only necessary that the messaging protocols are compatible.

FIG. 20d shows that the View-Controller of the appropriate type has been created and initialized and has been appropriately integrated into the View-Controller propagation-Web (green). Additionally this new View-Controller on Peer-D is locally associated with the appropriate Model on Peer-D, establishing a local Model/View-Controller relationship. At this point the local Model and View-Controller are fully functioning as participants in a Distributed Model/View-Control web and can provide all the functionality described earlier.

It is worth noting that view-controllers can generate change events at a rapid pace. For example scrolling a text area or rotating a 3D model may generate dozens of view port changes per second. This may produce acceptable behavior in a local Model/View-Controller, but in a Distributed implementation it may flood the network and/or introduce latencies into applications.

To reduce this flooding, View-Controllers can integrate coalescing filters for setting the view port values in their Distributed Hash table. A coalescing filter is constructed with a waitToInvoke. By setting values in the coalescing filter, the data will be held until the waitToInvoke interval has passed before propagating it. If it is set to another value before the waitToInvoke time has occurred, the old value is discarded and replaced by the new value. The most recent value set at when the waitToInvoke time is triggered will be the value that is sent and the timer is reset until the next time a value is set in the coalescing filter (restarting the waitToInvoke timer)

This technique could be applied to any rapidly changing view-adjuster such as scrollbars. For example, if a scrollbars generate local scroll events every 0.04 seconds and the waitToInvoke time is set to 0.2 second, there typically will be 5 local scroll events before the value is propagated to the View-Controller web with only the last value set being sent. Of course, there is a trade-off since we have introduced a 0.2 second scheduled latency (vs network traffic latency) for scrolling between peers even if there isn't a flood of events. Users who were watching screens sitting next to each other probably would not notice this amount of latency. Furthermore, it is extremely unlikely that users discussing synchronized views over the phone would ever observe this latency.

While preferred embodiments of the present invention have been shown and described, it will be understood by those skilled in the art that various changes or modifications can be made without varying from the scope of the present invention.

TABLE 1
Mirror-State Relationships between the local Peer's state and remote
Peer's State

| View Mirror | View Mirror | |
|---|---|---|
| State | State | |
| Local Peer | Remote Peer | Result |
| Lead on | Follow on | My view changes change his view |
| | | His view changes are mirrored locally |
| Lead off | Follow off | My view is unaffected by his view |
| | | His view changes are not mirrored locally |
| Follow on | Lead off | We want to follow him, but he does not |
| | | think we should |
| | | His view changes are not mirrored locally |
| Follow off | Lead on | He wants us to follow his changes but we are |
| | | configured to ignore them |
| | | His view changes are not mirrored locally |
| Follow on | Follow on | Completely Synchronized Views |
| Lead on | Lead on | My view changes change his view |
| | | His view changes are mirrored locally |
| Follow off | Follow off | Completely Desynchronized Views |
| Lead off | Lead off | His view changes are not mirrored locally |

Note that the Follow or Lead state can be implemented to maintained for each peer or may consist of a single value used for all peers

What is claimed is:

1. A method for providing feedback to multiple users of a computer application program having means for collaborative review and revision of a document comprising:
providing a means for enabling two or more users to simultaneously collaborate on a software application, each user accessing the application via a display, each user having means for displaying some or all of the document, and,
providing a visual indicator of each users location in the document,
providing a visual indicator for changes made by the user that are associated to that user being visually indicated on the users display, and
providing a visual indicator for displaying selection or pointing gestures by the various users.

2. The method of claim 1 further comprising providing means for users to lock out portions of the document, the indicators displaying to other users the portions locked out, and identifying the user who applied the lock out to those portions

3. The method of claim 1 wherein the visual indicators are selected from the group consisting of color, text box indicators, and graphical indicators.

4. The method of claim 1 further comprising providing the users with means to engage in communication.

5. The method of claim 4 wherein the means to communicate comprise an instant messaging module for exchanging information directly as the users collaborate on the document.

6. The method of claim 1 wherein the visual indicator is a modified scrollbar that indicates the position of other users in the document and the users position in the document such that each user can be working on different portions of the document and know by reference to the scrollbar where in the document the other users are working.

7. The method of claim 1 further comprising propagating to each user a model of the document with a complete set of data elements, propagating to each user each change made to each data element, determining a creator of each data element and a change lock owner on each data element so as to synchronize data elements in each users document and to limit changes to those authorized to change selected data elements.

8. The method of claim 7 wherein the change lock owner controls the entire document.

9. The method of claim 7 wherein multiple users are change lock owners for portions of the document.

10. The method of claim 7 wherein change lock ownership is assigned and reassigned during collaboration on the document among the users.

11. The method of claim 7 wherein upon termination of a user a selected default as to change lock ownership is initiated.

12. The method of claim 11 wherein the change lock ownership reverts to the document creator.

13. The method of claim 11 wherein the change lock ownership transferes along a defined hierarchy of users still interconnected and having access to the document.

14. A computer system for providing feedback to multiple users of a computer application program comprising providing multiple user terminals having means for collaborative review and revision of a document supported by software resident in the computer system, means for enabling two or more users to simultaneously collaborate on the software application supported document, each user accessing the application via a display, each user having means for displaying some or all of the document, and, visual indicator means for indicating the location in the document of each user, such that changes made by one user are associated to that user by the visual indication means on the other users displays, and having means for displaying selection or pointing gestures by the various users distinguishable by visual indication means.

15. The computer system of claim 14 further comprising means for at least one user to select and lock out portions of the document to prohibit other users from making revisions to the selected portions, the visual indicating means showing other users the portions so selected and the identity of the at least one user who applied the lock out to the selected portions.

16. The computer system of 14 wherein the visual indicator means are selected from the group consisting of color, text, graphics and combinations thereof.

17. The computer system of claim 14 further comprising communication means for users to communicate while revising the document.

18. The computer system of claim 14 wherein the visual indicator means is a modified scroll bar that indicates the position of other users in the document, and the users' current position in the document, so that each user can work on different portions thereof and know by reference to the scroll bar where the other users are working.

19. The computer system of claim 14 further comprising means for propagating to each user a model of the document with a complete set of data elements, means for propagating to each user each change made to each data element, means for determining a creator of each data element and a change lock owner on each data element so as to define means for synchronizing data elements in each users document and to limit changes to those authorized to change selected data elements.

20. The computer system of claim 19 wherein the change lock owner controls the entire document.

21. The computer system of claim 19 wherein multiple users are change lock owners for portions of the document.

22. The computer system of claim 19 wherein change lock ownership is assigned and reassigned during collaboration on the document among the users.

23. The computer system of claim 19 wherein upon termination of a user from the system, a selected default as to change lock ownership is initiated.

24. The computer system of claim 23 wherein the change lock ownership reverts to the document creator.

25. The computer system of claim 23 wherein the change lock ownership is transferred along a defined hierarchy of users still interconnected and having access to the document.
